(19) United States
(12) Patent Application Publication
(10) Pub. No.: US 2009/0016048 A1
(43) Pub. Date: Jan. 15, 2009

(54) TORCH LAMP SYSTEMS, FLAME LAMP ASSEMBLIES, AND LAMPS WITH SWIRLING FLAMES

(75) Inventors: Russ McBrien, Mukilteo, WA (US); Kurt W.F. Rumens, Snohomish, WA (US); Alan R. Atemboski, Reston, WA (US)

Correspondence Address: PERKINS COIE LLP;PATENT-SEA, P.O. BOX 1247, SEATTLE, WA, 98111-1247, US

(73) Assignee: Travis Industries, Inc., Mukilteo, WA (US)

(21) Appl. No.: 12/030,843

(22) Filed: Feb. 13, 2008

Related U.S. Application Data
(60) Provisional application No. 60/894,864, filed on Mar. 14, 2007.

(51) Int. Cl. F21S 13/00; F23C 7/00

(52) U.S. Cl. 362/180; 431/8; 431/125

(57) ABSTRACT

Torch lamp systems and flame lamp assemblies for producing swirling flames are disclosed herein. In one embodiment, a flame lamp assembly for providing a flame having a continuous spiral movement can include a plurality of spaced apart panels and a frame for supporting the panels to form a chamber for housing the flame. The frame can support the panels such that adjacent panels are spaced apart at panel junctions to create a plurality of air intake slots. The plurality of air intake slots can be in communication with the chamber to allow air to flow from an external environment into the chamber at an angle to provide vortical air flow within the chamber. The assembly can also include a burner assembly configured to receive fuel from a fuel source and to provide a fuel flow from a fuel release point to the chamber for ignition to provide the flame.

### CROSS-REFERENCE TO RELATED APPLICATIONS

This application claims priority to U.S. patent application Ser. No. 60/894,864 filed Mar. 14, 2007, entitled FLAME LAMP ASSEMBLY WITH SWIRLING FLAME, which is incorporated herein by reference in its entirety.

### TECHNICAL FIELD

The present disclosure is generally directed to torch lamp systems, and more particularly to lamp assemblies and systems having a fuel source to provide an open flame.

### BACKGROUND

Conventional torch lamps or lanterns are used for outdoor lighting, festive lighting, ambiance, to provide warmth, etc. Additionally torch lamps can be used to mark walkways or to deter insects from a selected area. Typically, torch lamps are permanently installed or fixed to moveable structures that can be placed on patios, garden areas, picnic and/or outdoor eating areas. Many torch lamps can provide a flame fueled by vaporous gas (e.g., natural gas, propane, kerosene, etc.), while others can be fueled with liquid, solid, or particle-based fuel.

### SUMMARY

The present disclosure is directed generally toward torch lamp systems and flame lamp assemblies for producing swirling flames. One aspect of the disclosure is directed toward a torch lamp system connectable to a source of fuel. In one embodiment the system includes a burner assembly connectable to the source of fuel and configured to release fuel at a fuel release point for combustion to provide a flame. The system can also include a lamp assembly having an interior chamber configured to contain the flame swirling vortically due to air convection therein. The chamber can be positioned above the fuel release point and have an open upper end portion. Additionally, the chamber can be defined by a plurality of panels positioned adjacent to one another along vertical panel edges and spaced apart from one another by gaps. The gaps provide vertically oriented air intake slots between adjacent panels to provide vortical convection airflow therein for swirling the flame. The torch lamp system can further include a fuel dispersal guide in the chamber positioned above the fuel release point. The fuel dispersal guide can be positioned so that fuel flowing from the fuel release point is distributed radially outward from the fuel release point toward the panels.

Another aspect of the disclosure is directed toward a flame lamp assembly for providing a flame having a continuous spiral movement. In one embodiment, the flame lamp assembly can include a plurality of spaced apart panels and a frame for supporting the panels. The panels can be generally vertically oriented and positioned by the frame to form a chamber for housing the flame. The frame can support the panels such that adjacent panels are spaced apart from each other at panel junctions along vertical edges of the panels to create a plurality of air intake slots in communication with the chamber. Additionally, the panels can be off-set from adjacent panels. Furthermore, the plurality of air intake slots can be in communication with the chamber to allow air to flow from an external environment into the chamber at an angle to provide vortical air flow within the chamber. The flame lamp assembly can also include a burner assembly positioned below the chamber and configured to receive fuel from a fuel source and to provide a fuel flow from a fuel release point to the chamber for ignition to provide the flame.

A further aspect of the disclosure is directed toward a torch lamp system including a flame lamp assembly. In one embodiment the flame lamp assembly includes a burner assembly for receiving fuel from a fuel source and releasing fuel at a fuel release point. The flame lamp assembly can also include a base positioned over the burner assembly and an inlet disposed in the base. The inlet can be aligned with the fuel release point such that fuel is directed through the inlet. The flame lamp assembly can further include a chamber supported by the base in a generally vertical orientation and having an open upper portion spaced apart from the base, the chamber defined by a plurality of panels positioned adjacent to one another along vertical panel edges and spaced apart from one another by gaps. The gaps provide vertically oriented air intake slots between adjacent panels. The flame lamp assembly can also include a fuel dispersal guide in the chamber. The fuel dispersal guide can have a plate supported at a selected distance above the inlet disposed in the base so that fuel flowing from the fuel release point and through the inlet is distributed radially outward from the fuel release point.

### BRIEF DESCRIPTION OF THE DRAWINGS

In order that features and characteristics of the disclosure will be readily understood, a more particular description of aspects of the disclosure briefly described above will be rendered by reference to specific embodiments and the appended drawings. Understanding that these drawings depict only typical embodiments of the disclosure and are not therefore to be considered to be limiting of its scope, the disclosure will be described and explained with additional specificity and detail through the use of the accompanying drawings.

FIG. 1 is a partially schematic isometric view illustrating a torch lamp system including a flame lamp assembly in accordance with an embodiment of the present disclosure.

FIG. 2 is a partially schematic, cross-sectional side view taken substantially along line 2-2 of FIG. 1 illustrating the torch lamp system of FIG. 1.

FIG. 3 is a partially schematic, top plan view of the flame lamp assembly of FIG. 1 with a cap removed and illustrating air flow patterns in accordance with an embodiment of the present disclosure.

FIG. 4 is an isometric view illustrating a base platform and a fuel dispersal guide in accordance with an embodiment of the present disclosure.

FIG. 5 is an enlarged isometric view of the flame lamp assembly of FIG. 1 showing air intake slots between adjacent panels.

FIG. 6 is a top isometric view illustrating a burner assembly in accordance with an embodiment of the present disclosure.

FIG. 7 is an isometric view illustrating a mounting assembly of the torch lamp system in accordance with an embodiment of the present disclosure.

FIG. 8 is an isometric view illustrating a transportable mounting assembly of the torch lamp system in accordance with another embodiment of the present disclosure.

FIG. 9A is an isometric view illustrating a wall-mounting assembly of the torch lamp system in accordance with an embodiment of the present disclosure.

FIG. 9B is a cross-sectional view taken substantially along line 9B-9B of FIG. 9A of the wall mount assembly.

FIG. 10 is an isometric view illustrating a torch lamp system including a flame lamp assembly in accordance with another embodiment of the disclosure.

### DETAILED DESCRIPTION

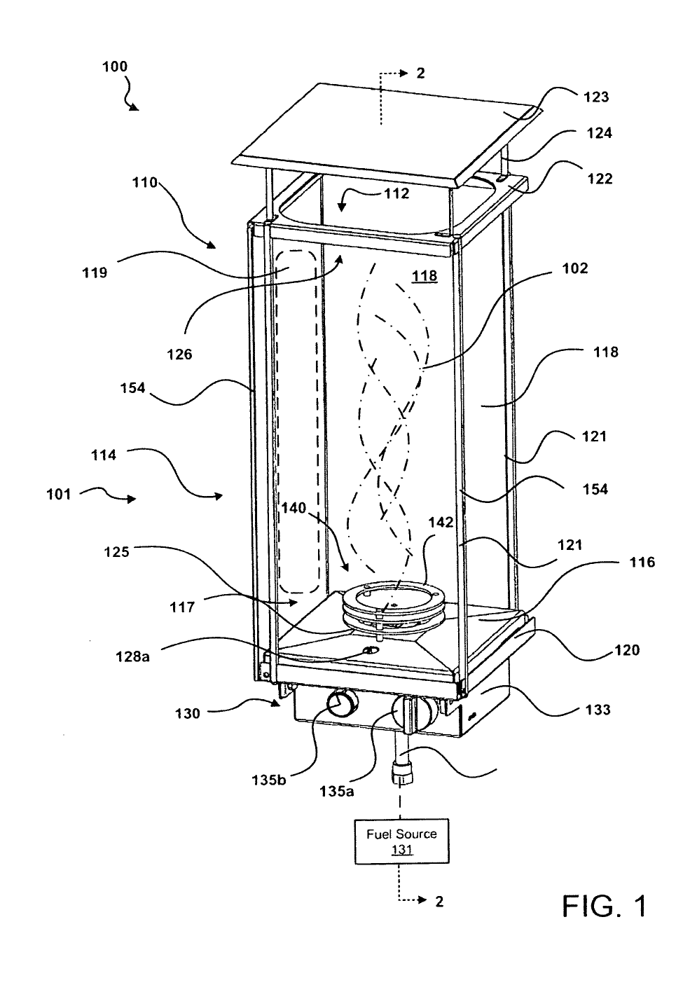

The present disclosure describes embodiments of torch lamp systems that provide a distinctive, swirling flame movement. Several specific details of the disclosure are set forth in the following description and in FIGS. 1-10 to provide a thorough understanding of certain embodiments of the disclosure. One skilled in the art, however, will understand that the present disclosure may have additional embodiments, and that other embodiments of the disclosure may be practiced without several of the specific features described below.

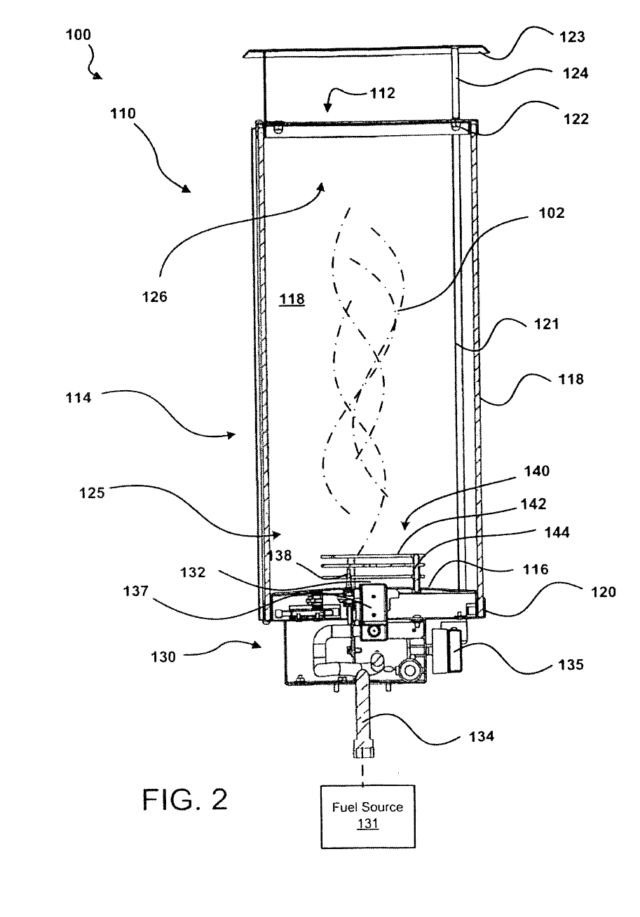

FIG. 1 is a partially schematic isometric view and FIG. 2 is partially schematic, cross-sectional side view of a torch lamp system 100 in accordance with an embodiment of the present disclosure. Referring to FIGS. 1 and 2 together, the torch lamp system 100 includes a flame lamp assembly 101 with a lamp 110 and a burner assembly 130 for metering and delivering fuel from a fuel source 131 (shown schematically) to a fuel release point 132 and into the lamp 110. The burner assembly 130 can be protected within a housing 133 (shown in FIG. 1) positioned in a bottom portion of the lamp 110. The flame lamp assembly 101 operatively uses a vertical chamber design configuration (described in more detail below) that creates a flow of air in a circular or otherwise vortical pattern within the lamp 110 via air convection such that a flame 102 is caused to move in a vortical pattern.

As illustrated, the lamp 110 provides a flame chamber 112 to house the flame 102 while the fuel and convection air flow are directed into the chamber. The lamp 110 of the illustrated embodiment includes a chamber frame 114, a base platform 116 and a plurality of panels 118. The chamber frame 114 defines the general size and shape of the lamp 110 as well as the internal volume of the flame chamber 112 created within the lamp 110. The chamber frame 114 can position and support the base platform 116 and the plurality of panels 118 in a selected position that facilitates the swirling convection air flow into the flame chamber and the delivery of the fuel in a selected air-fuel mixture for ignition in the flame chamber. In one embodiment, the chamber frame 114 can include a base support 120 and a plurality of vertical support bars 121 coupled to the base support 120 for supporting the plurality of panels 118 in a generally vertical orientation. The chamber frame 114 can also include a top support 122 positioned apart from the base support 120 and coupled to an opposite end of the vertical support bars 121. In other embodiments, the chamber frame 114 may not include the vertical support bars 121 and/or the top support 122. For example, the panels may be rigidly fixed in a vertical orientation with the base support 120.

The base platform 116 can be fitted in the base support 120 of the chamber frame 114 and can be configured to cover and/or be positioned over the burner assembly 130. The base platform 116 includes an inlet 117 aligned with the fuel release point 132 of the burner assembly 130 and is positioned to receive fuel into a bottom portion 125 of the flame chamber 112 for ignition. The base platform 116 can also include one or more orifices 128a for inserting igniters, matches, or other ignition sources for lighting the released air-fuel mixture inside the chamber 112. The chamber frame 114 and the base platform 116 can include a durable, heat-resistant material such as metal, heat and/or fire resistant polymers, etc. The components of the chamber frame 114 (e.g., vertical support bars 121, top support 122, base support 120, etc.) can be securely fastened or otherwise connected to other chamber frame components using a plurality of fastening devices (not shown) and/or materials (e.g., screws, nuts and bolts, nails, adhesive, etc.).

The plurality of panels 118 can be supported in a generally vertical orientation relative to the base platform 116 and each individual panel 118 can be aligned along vertical edges 154 to adjacent panels. As illustrated in FIG. 1, the lamp 110 can include four panels 118. In one embodiment, the panels 118 can be positioned generally perpendicular to adjacent panels to form a generally rectangular chamber 112. In other embodiments, the chamber frame 114 can support a different number of panels 118 (e.g., 3 panels, 5 panels, 6 panels, etc.) and can have the panels positioned to form a variety of shapes.

As illustrated in FIGS. 1 and 2, the lower portion 125 of the chamber 112 can be positioned on or adjacent to the base platform 116 such that the chamber 112 is oriented in an upright manner with an open upper portion 126 spaced apart from the base platform 116 and exposed to the surrounding environment (seen in FIGS. 1 and 2). In some embodiments, the lamp 110 can also include a top cover 123 supported above the chamber 112 with a plurality extension legs 124. The top cover 123 may be positioned at a variety of distances above the chamber 112 and/or panels 118 such that debris, moisture, combustible material, etc., is prevented from falling into the chamber 112 while still allowing heated air to pass out of the open upper portion 126 of the chamber.

The plurality of panels 118 in the illustrated embodiment can be transparent and clear. In another embodiment, the panels 118 can be tinted, frosted, etched, patterned, or otherwise decorated while still providing visibility to the flame 102 within the chamber 112. Each of these panels 118 may be made of a durable, heat-resistant and/or fire-resistant material, such that when the lamp 110, including the chamber frame 114, is fully assembled, there is sufficient structural integrity to freely stand. The panels 118 are also configured to withstand high heat and flames 102. For example, the panels 118 may be made of glass, such as tempered glass or ceramic glass. In one embodiment, the panels 118 can be generally clear and the lamp 110 can include one or more removable and/or replaceable decorative overlays 119 (FIG. 1 shown in phantom lines) positioned adjacent to the panels 118 and configured to provide the panels with pattern, images, color, and/or a combination of these or other visual aesthetic characteristics through which to view the flame 102. In some embodiments, the decorative overlays 119 can be positioned in the chamber and adjacent to the panels 118, while in other embodiments, the decorative overlays 119 can be positioned adjacent to an exterior surface of the panels 118.

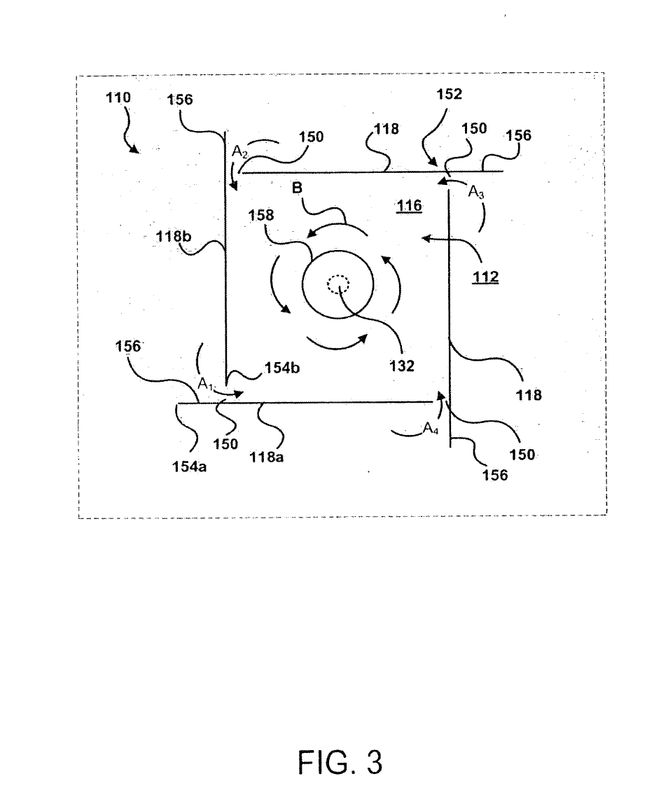

FIG. 3 shows a top view of one embodiment of a lamp 110 illustrating air intake slots 150 between the panels 118 and in communication with the chamber 112. The plurality of panels 118 can be coupled to or positioned by the base support 120 of the chamber frame 114 such that the panels 118 are spaced apart at vertical junctions 152 along adjacent vertical edges 154 to create the air intake slots 150 (e.g., gaps between adjacent panels). The air intake slots 150 are positioned in a manner that allows air to flow into the flame chamber 112 at a selected angle to provide air flow in a helical or vortical pattern within the chamber 112.

In one embodiment, the panels 118 are joined while preserving elongated air intake slots 150 between the sides of the panels 118. For example, the plurality of panels 118 may be aligned to form a chamber 112 wherein one vertical edge 154a of a panel 118a is spaced apart from and extends beyond the abutting vertical edge 154b for an adjoining panel 118b. In this embodiment, each panel 118 has an extension portion 156 that extends beyond the vertical edge 154 of the adjacent panel 118. The extension portion 156 acts to direct external airflow through the air intake slots 150 and into the interior (Arrows A₁-A₄) of the chamber 112. The airflow through the air intake slots 150 is initially generally adjacent to the inner surfaces of the panels 118, and this airflow pattern causes a swirling or spiral motion of air (B) within the chamber 112 around the fuel release point 132. The spiraling motion of air (B) around an axis 158, due to convection, pushes the flame 102 (e.g., FIG. 1) in a corresponding pattern.

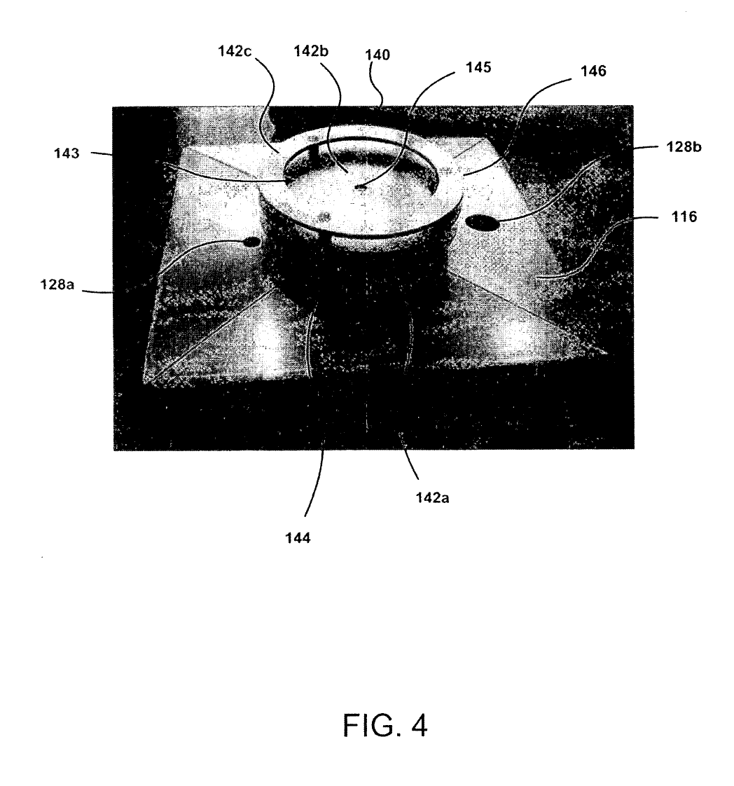

Referring back to FIGS. 1 and 2, the lamp 110 of the illustrated embodiments includes a fuel dispersal guide 140 for directing fuel flow. The fuel dispersal guide 140 can be positioned in the chamber 112 over the fuel release point 132 and or inlet 117 disposed in the base platform 116. In one embodiment, the fuel dispersal guide 140 can rest on the base platform 116. FIGS. 1 and 2 show the fuel dispersal guide 140 supported on the base platform 116 of the lamp 110. Additionally, FIG. 4 is an isometric view illustrating a base platform 116 and a fuel dispersal guide 140 shown removed from the lamp 110 and in accordance with an embodiment of the present disclosure. Referring to FIGS. 1-2 and 4, the fuel dispersal guide 140 can include one or more heat and/or fire resistant plates 142 (e.g., 142a-142c shown in FIG. 4) supported above the base platform 116 by legs 144, such that the bottom of the fuel dispersal guide 140 is directly impacted by the flow of fuel from the fuel release point 132 just after the fuel is ignited so as to create radial dispersal of the burning fuel (i.e., flames) toward the panels 118.

In the illustrated embodiment shown in FIGS. 1-2 and 4, the fuel dispersal guide 140 includes a stack of three plates 142a-c positioned above the burner assembly. In one embodiment, the first plate 142a and the third plate 142c are ring-shaped with open center portions 143. The second plate 142b can be a substantially solid plate having one or more small hole(s) 145 disposed in the plate 142b such that a portion of fuel flowing from the fuel release point will pass centrally through the small hole(s), while other portions of the fuel will hit the bottom of the second plate and flow around the fuel dispersal guide 140 toward the side panels 118. In the illustrated embodiment, the ring-shaped bottom plate and the ring-shaped upper plate (e.g., first and third plates 142a and 142c) help disperse the fuel flow to provide a fuel-and-air mixture that burns efficiently and clearly. In this embodiment, the swirling flame 102 may be created to appear to have a more full or voluminous appearance within the chamber 112. In other embodiments, the fuel dispersal guide 140 can have a different number of stacked plates 142. For example, the fuel dispersal guide 140 can have a single solid plate 142 having one or more small hole(s) 145 disposed in the plate. In other embodiments, the fuel dispersal guide 140 can have two plates 142 or more than three plates 142. In another embodiment, the fuel dispersal guide can include one or more shaped plates (with or without holes therein) spaced apart from the burner assembly so as to spread the fuel radially toward the panels as it burns into the swirling convective airflow within the chamber.

Together, the plates 142a-c smoothly direct the fuel radially outward within the chamber 112 and facilitate mixing the fuel with larger volumes of air. In one embodiment, the air-fuel mixture that occurs around and adjacent to the fuel release point 132 and the fuel dispersal guide 140 near the bottom portion 125 of the chamber 112 allows for efficient and clean burning of the fuel and inhibits significant buildup of by-product (e.g., carbon) on the inner surfaces of the panels 118. The fuel dispersal guide 140 is shaped to direct fuel flow radially outwardly toward the outer edge 146 (FIG. 4) of the fuel dispersal guide 140, toward the panels 118 and into the spiraling air flow from the air intake slots 150. Beneficially, the fuel is dispersed in a pattern similar to the shape of the fuel dispersal guide 140 (e.g., circular, oval, square, triangular, etc.). In one embodiment, the fuel dispersal guide 140 includes a concave plate 142, and in other embodiments, the fuel dispersal guide 140 includes one or more generally flat or convex-shaped plates 142.

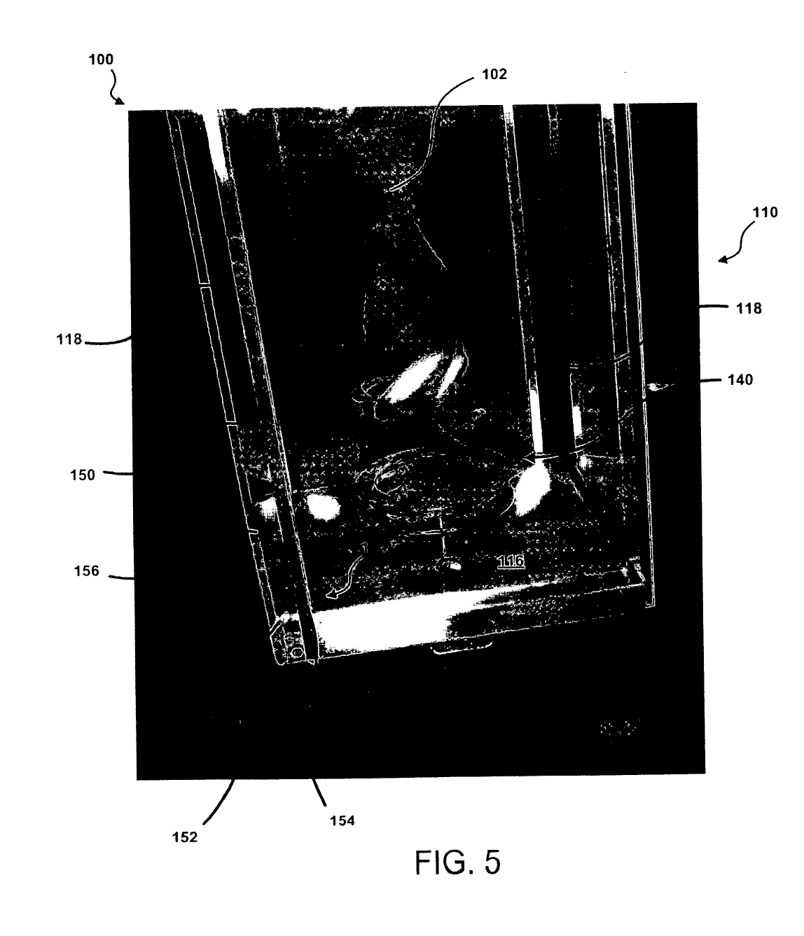

FIG. 5 is a partially schematic, enlarged side view of the lamp 110 of FIG. 1 showing the air intake slots 150 between adjacent panels 118. In one embodiment, the chamber frame 114 can position a vertical edge 154 of a first panel 118 adjacent to and generally perpendicular to an interior vertical portion of a second panel 118 such that the second panel has the extension portion 156 on the exterior of the lamp 110. In another aspect of the illustrated embodiment, the chamber frame 114 positions the panels 118 such that the space between the panels 118 at the vertical junctions 152 provides the air intake slots 150 between the panels such that air may flow into the chamber 112 of the lamp 110 (FIGS. 1 and 2).

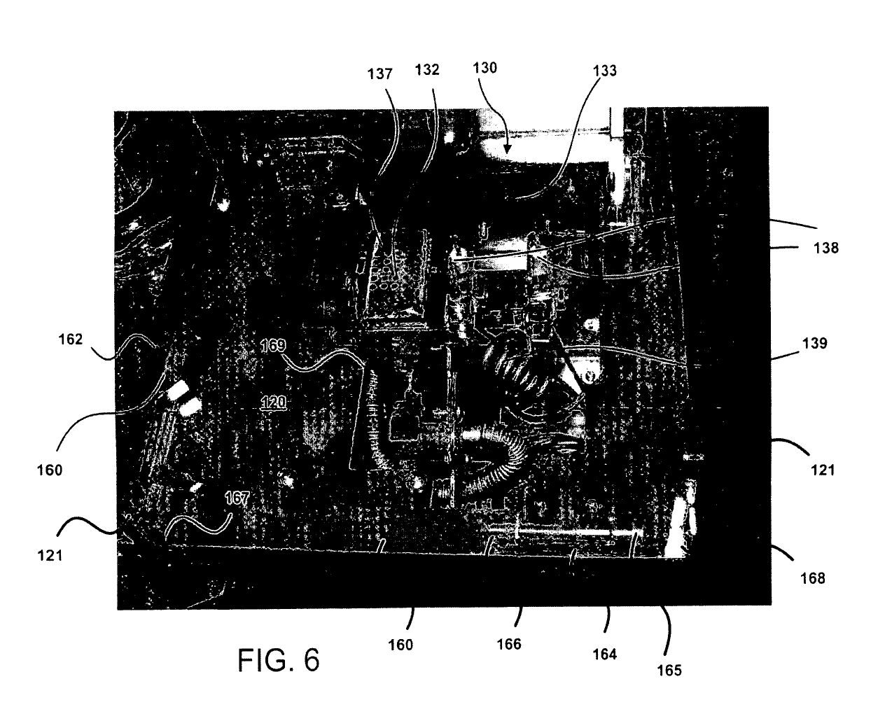

The physical space maintained between the panels 118 may be preserved with the use of spacers (not shown) or by securing the panels 118 with the base support 120 of the chamber frame 114 in a manner to accommodate additional space between the panels 118. For example, FIG. 6 is a partially schematic, top view illustrating the base support 120 partially covering the burner assembly 130 in accordance with an embodiment of the present disclosure. As shown in the embodiment of FIG. 6, the base support 120 can include a plurality of panel slots 160 formed between a raised rim 162 of the base support 120 and a plurality of pressure bars 164 disposed on the bottom of the base support 120 adjacent to the raised rim 162. In one embodiment, the pressure bars 164 can include a screw-driven pressure plate 166 that can be applied to a bottom portion (not shown) of an inserted panel 118 to prevent the panel from moving from or within the panel slots 160. Accordingly, the position of the panels 118 can be adjusted, such as to fix or adjust the size of the air intake slots 150. In one embodiment, the panel 118 can be positioned so all of the air intake slots 150 are the same size. In other embodiments, the panels can be positioned so two or more of the slots have different sizes. The size(s) of the air intake slots are selected to provide and/or control the characteristics of the swirling convective air flow within the chamber and thereby controlling at least some of the characteristics of the swirling flame in the lamp.

Once the panel 118 is placed in a desired location within the panel slot 160, a screw 165, such as a thumb screw, can be rotated to engage a back side of the screw-driven pressure plate 166 to press the pressure plate 166 against the bottom portion (not shown) of the panel 118 to prevent the panel from moving. Likewise, if the panel 118 needs to be removed from the chamber frame 114, the screw 165 can be rotated in an opposite direction to release pressure on the panel 118 from the screw-driven pressure plate 166.

In some embodiments, the vertical support bars 121 can extend from the base support 120 and define the terminal end 167 of the panel slot 160. The terminal end 167 is generally not flush with a corner region 168 of the base support 120. Accordingly, in one embodiment, the distance between the corner region 168 and the terminal end 167 defines a width of the air intake slot 150 (as shown in FIG. 5). In a further embodiment, the raised rim 162 can be notched at the corner regions 168, as shown, such that the panel 118 can slide through the corner region 168 and into the panel slot 160 until it butts against the vertical support bar 121 at the terminal end 167. In some embodiments, the panels 118 can be set into the panel slots 160, and in yet further embodiments, the panels 118 can be placed within the panel slots 160 at any distance from the terminal end 167. Additionally, the panel 118 may be able to extend beyond the corner region 168 to provide the extended portion 156 (shown in FIGS. 3 and 5).

The torch lamp system 100 also includes the burner assembly 130 for delivering fuel and metering flow rate of the fuel to the lamp 110. Referring back to FIG. 2, the illustrated embodiment shows a partially schematic, cross-sectional side view of the burner assembly 130, without the housing 133, and positioned below the lamp 110. In the illustrated embodiment, fuel can be directed from the fuel source 131 (shown schematically) to the burner assembly 130 via a fuel intake hose or tube 134. The torch lamp system 100 may utilize a variety of fuels known in the art including, but not limited to, propane, kerosene, natural gas, and the like.

The burner assembly 130 can also include a fuel flow valve control 135a for allowing a user to open, close, or otherwise adjust a fuel flow valve (not shown), thereby controlling the flow of fuel through the burner assembly to the fuel release point 132. Additionally, the fuel flow valve control 135a can allow a user to control flow rate of the fuel to manage flame volume and/or height within the lamp 110 during operation. For example, the fuel flow valve control 135a can be a dial knob (shown in FIGS. 1 and 2) that can control the amount of fuel delivered through the burner assembly 130.

FIG. 6 illustrates a partially schematic, top view of the burner assembly 130 in accordance with an embodiment of the invention. Referring to FIGS. 2 and 6 together, fuel can flow to a burner 137 when the fuel valve (not shown) is in an open state. The burner 137 includes the fuel release point 132 that directs the flow of fuel through an opening 169 disposed in the base support 120, and through the inlet 117 disposed in the base platform 116 (shown in FIG. 1). In one embodiment, the lamp 110 is positioned above the burner 137 of the burner assembly 130 and, specifically, above the fuel release point 132 such that the fuel release point 132 is surrounded by the plurality of panels 118.

In some embodiments, the fuel release point 132 is positioned to deliver fuel through a center portion of the base platform 116 and in alignment with a central axis, such as axis 158 (FIG. 3), of the flame chamber 112. In other embodiments, the fuel release point 132 may be positioned at other locations in the base platform 116 relative to the flame chamber 112. In one embodiment, the fuel release point 132 can be provided at an end of a tube or other fuel line at or above the base platform 116. In a further embodiment, the fuel release point 132 may include a collection of several small holes disposed in the burner 137 (as shown in FIG. 6). It is understood that any orifice disposed in the base platform 116 and connected to a fuel source 121 may serve as a fuel release point 132 for the torch lamp system 100.

Referring back to FIGS. 2 and 6, the torch lamp system 100 can also include one or more flint or other igniters 138 for igniting the air-fuel mixture just after the fuel has passed from the burner assembly 130 into the chamber 112. In the embodiment shown in FIG. 2, the base platform 116 can include an orifice 128b (shown in FIG. 4) positioned to allow the igniter 138 to extend above the base support 120 and the base platform 116 for igniting the fuel inside the chamber 112 and/or at least adjacent to the inlet 117. In one embodiment, the burner assembly 130 can include two or more igniters 138 to provide a backup ignition means, such as if one of the igniters is temporarily wet or otherwise ineffective.

Additionally, the burner assembly can include an ignition switch 135b (shown in FIG. 1) accessible on the exterior of the housing 133, for operatively engaging the igniter 138 while opening the fuel valve with the fuel flow valve control 135a. As noted above, the fuel may be ignited by a user with a match or other external flame or spark. For example, the user can insert the match or external flame into the orifice 128a (shown in FIGS. 1 and 4) to manually ignite the fuel as it enters the flame assembly chamber 110.

As shown in FIG. 6, the burner assembly 130 can also include a thermocouple 139 for sensing the absence of a flame 102 when the fuel flow valve is open and for automatically closing the fuel flow valve (not shown) when un-combusted fuel is released from the fuel release point 132. If the flame 102 becomes extinguished for any reason, there is the potential for un-combusted gas to be released into the surrounding area. Accordingly, the tip of the thermocouple 139 can be positioned adjacent to the burner 137 and/or the fuel release point 132 for detecting the presence of heated air near the flame 102. In this embodiment, and in the presence of a flame 102, the thermocouple remains hot and holds the fuel flow valve in an open state. If the fuel is not ignited and/or the flame 102 is extinguished, the temperature of the air near the tip of the thermocouple 139 will be below a threshold level and result in an automatic closure of the fuel flow valve to prevent further fuel release to the burner 137.

Referring to FIGS. 1-6, when the torch lamp system 100 is turned “on,” such that the fuel is flowing into the chamber 112, the fuel flow is ignited within the chamber 112. The burning fuel within the chamber 112 heats the air in the chamber 112, and the heated air rises. As the heated air and burning fuel rise (and exits through the open upper portion 126 of the chamber 112), additional air is drawn into the chamber 112 through the air intake slots 150 through natural convection and into the spiraling motion (B) as discussed above.

In operation, the torch lamp system 100 provides a flame 102 that moves in a substantially helical or vortical pattern up the chamber 112. As the air moves into the chamber 112 through the air intake slots 150 and circulates in the spiral motion (B) discussed above, the air comes in contact with the flow of burning fuel such that the resulting flame 102 in the lamp 110 moves in a helical fashion corresponding to the rising vortex of air present in the chamber 112. Accordingly, the spiraling flame 102 is created using natural convection and without requiring additional blowers or fans to create a swirling airflow within the chamber 112.

In some embodiments, the rate of fuel flow may be altered to a desired flow rate. The size of the flame 102 may depend on the rate of fuel flow from the fuel release point 132. As discussed above, the fuel flow rate may be adjusted with the fuel flow valve control 135a associated with the burner assembly 130. In another embodiment, the fuel flow rate may be increased or decreased by an adjustment at the fuel source 121.

When the torch lamp system 100 is activated, such that the burner assembly 130 is “on” and fuel is delivered to the fuel release point 132, and the fuel is ignited to produce a flame 102, the flame 102 swirls within the flame chamber 112. The fuel dispersal guide 140 facilitates the mixture of air with the fuel as the fuel enters through the inlet 117 in the base platform 118, and directs the fuel/air mixture to be burned away from the fuel release point 132 providing a flame 102 with a wide base. In one embodiment, the characteristics of the flame 102 can be adjusted by positioning the fuel dispersal guide 140 in an off-center orientation relative to the fuel release point 132 and/or relative to the central axis of the chamber 112. This off-center orientation of the fuel dispersal guide 140 can create an asymmetrical flow of fuel within the chamber 112, thereby altering the shape of the spiraling flame 102.

The torch lamp system 100 can be operated in any open air venue, such as, outdoors, garden areas, indoor patio areas, indoor rooms having sufficient air circulation, etc. Those of ordinary skill in the art will recognize that the size and shape of each panel 118 and the overall size and shape of the lamp 110 and the torch lamp system 100 may vary to accommodate various space restrictions, gas flow restrictions, airflow requirements, and user preference without substantial adverse affects to the benefits of the present disclosure.

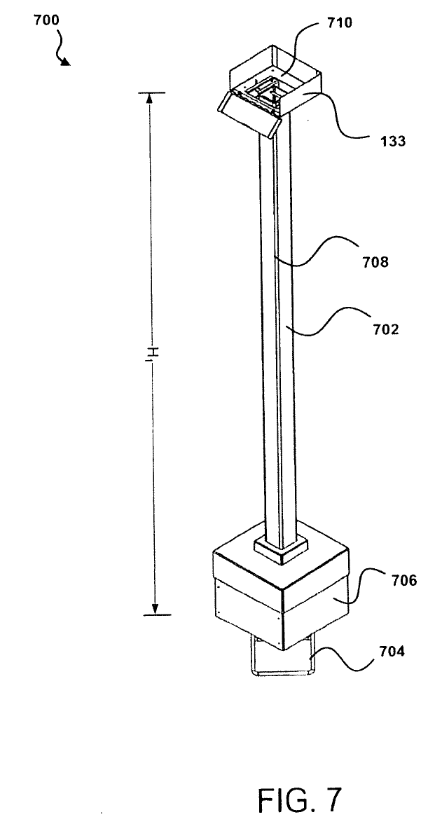

The torch lamp system 100 can be mounted in a variety of locations using mounting assemblies. FIG. 7 is a partially schematic, isometric side view illustrating a mounting assembly 700 for supporting a flame lamp assembly 101 in an elevated position in accordance with an embodiment of the present disclosure. In the illustrated embodiment, the mounting assembly 700 can be used for mounting a flame lamp assembly 101 on a fixed hollow post 702 and be connected to a fixed and/or “hard” fuel line 704 (shown in dotted lines). The fixed hollow post 702 can be stabilized by a base 706 and can be configured to extend a desirable height H₁ above the fuel line 704 and/or the base 706. A fuel carrier line 708 can be configured to carry the fuel up the height H₁ inside the fixed hollowed post 702 to an elevated post platform 710. In some embodiments, the elevated post platform 710 can include the housing 133 for the burner assembly 130.

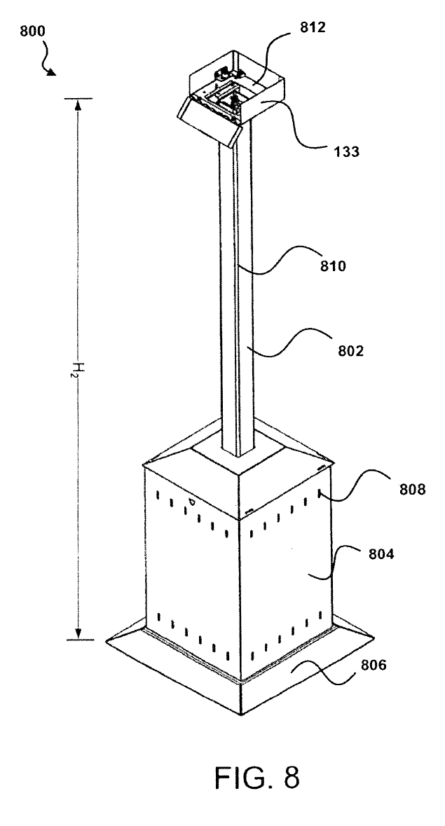

In another embodiment, the torch lamp system 100, including the fuel source (not shown) can be transportable. FIG. 8 is a partially schematic, isometric side view illustrating a transportable mounting assembly 800 for supporting a flame lamp assembly 101 in accordance with an embodiment of the present disclosure. In the illustrated embodiment, the flame lamp assembly 101 can be mounted on a hollow post 802 that extends a selectable height H₂ above a fuel source carrier 804 supported by a base 806. The fuel source carrier 804 can be configured to house a transportable fuel source (not shown) to any desired location, and may include carrier slots 808 for providing ventilation of the fuel source carrier 804. In one specific example, the fuel source can be a transportable propane tank. A fuel line 810 can extend inside the hollow post 802 from the fuel source in the fuel source carrier 804, along the height H₂, to an elevated post platform 812. In some embodiments, the elevated post platform 812 can include the housing 133 for the burner assembly 130.

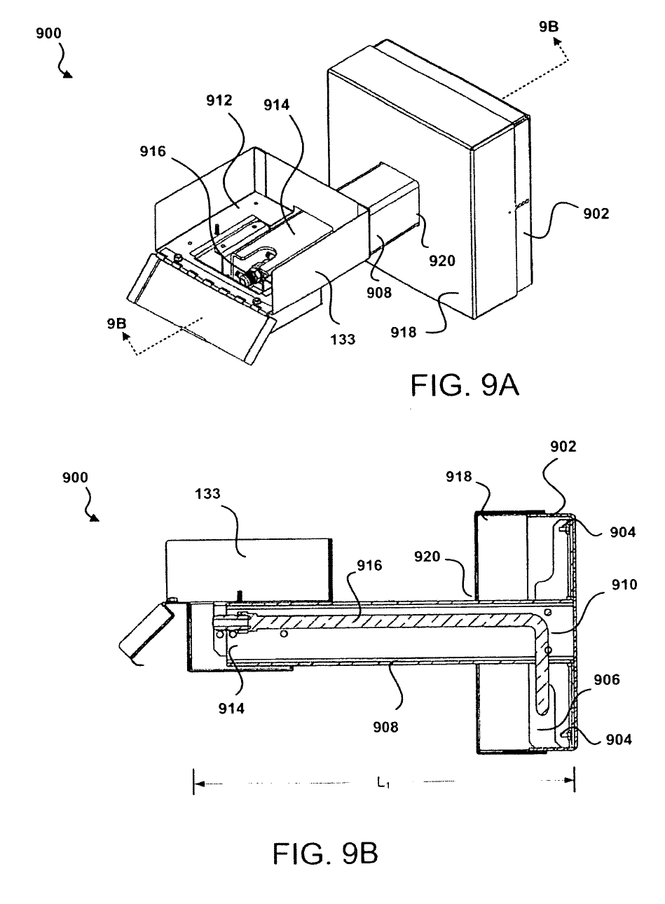

FIGS. 9A and 9B are a partially schematic, isometric side view and a partially schematic, cross-sectional side view, respectively, illustrating a wall-mounting assembly 900 for supporting a flame lamp assembly 101 on a substantially vertical or sloped surface (not shown), such as a wall, house siding, or other erected building structure, in accordance with an embodiment of the present disclosure. Referring to FIGS. 9A and 9B together, the wall-mounting assembly 900 can include a wall bracket 902 for attaching to the vertical surface. The wall bracket 902 can be attached with a variety of bracket fasteners 904 (shown in FIG. 9B). Bracket fasteners 904 may be any mechanical fastener suitable for securing the wall bracket 902 to the vertical surface (e.g., screws, nails, nuts and bolts, etc.).

A fixed fuel line 906 can be aligned with the secured wall bracket 902. The wall-mounting assembly 900 can also include a hollow extension post 908 secured to and extending from the wall bracket 902 and a secured end 910. The hollow extension post 908 can extend from the wall bracket 902 a desirable length L₁ from the vertical surface. The wall-mounting assembly 900 can also include a mounting platform 912 attached to an extended end 914 of the hollow extension post 908 and sized for receiving the flame lamp assembly 101. In some embodiments, the mounting platform 912 can include the housing 133 for the burner assembly 130. A fuel carrier line 916 can extend inside the hollow extension post 908 from the fixed fuel line 906 to the mounting platform 912 for delivering fuel to the burner assembly 130. As shown in the illustrated embodiment, the wall-mounting assembly 900 can also include a wall bracket cover 918 sized to cover the wall bracket 902. The wall bracket cover 918 includes a post aperture 920 for receiving the hollow extension post 908.

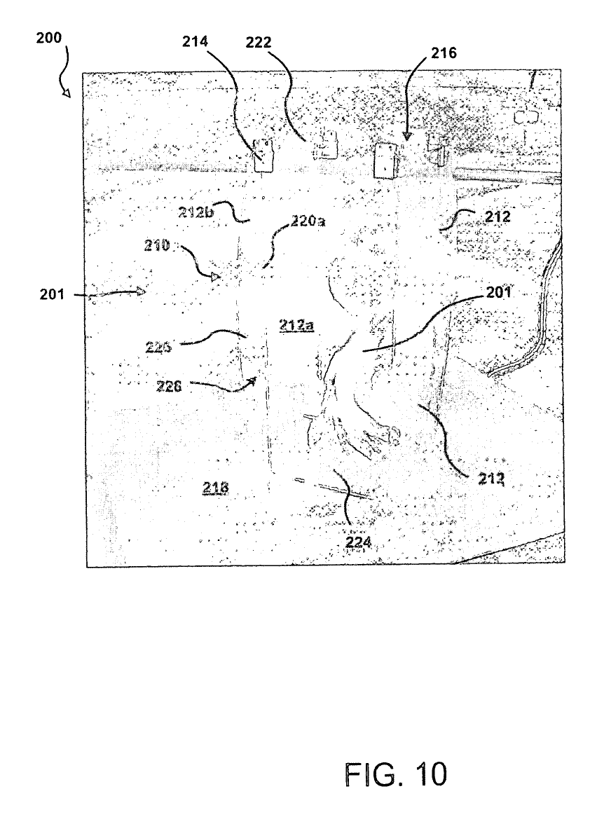

FIG. 10 is a partially schematic, side view illustrating a torch lamp system 200 including a flame lamp assembly 201 in accordance with another embodiment of the disclosure. This system 200 can include several features generally similar to the system 100 described above with respect to FIGS. 1-6. The system 200 differs from the system 100, however, in that the system 200 includes a lamp 210 that has a plurality of panels 212 linked with a plurality of panel fasteners 214 to form a flame chamber 216. The chamber 216, in one embodiment is free-standing on a base 218. In another embodiment, the chamber 216 is moveable relative to the base 218. In a further embodiment, the chamber 216 can be fixedly mounted on the base 218. In one embodiment, the base 218 can be a table-top or other flat surface for supporting the lamp 210.

The lamp 210 may not include a frame or other support feature for securing the panels 212 in a generally vertical position. Referring to FIG. 10, the plurality of panel fasteners 214 may, in one embodiment, be utilized to connect the plurality of panels 212 at positions along vertical edges 220 and/or top edges 222 of the panels 212. In another embodiment, panel fasteners 214 may secure panels 212 to the base 218 such that the panels 212 are positioned so the chamber 216 is disposed directly above a fuel release point 224 disposed in the base 218. In a further embodiment, the base 218 may include groves (not shown) to receive the panels 212, such that panels 212 stand upright without the need for additional panel fasteners 214.

Panel fasteners 214 may be any mechanical embodiment that connects panels 212 together or connects panels 212 to the base 218. Panel fasteners 214 may include, but are not limited to, clamps, hinges, adhesive, a corresponding pair of hook and loop strips, bracket and screws, or other fastening devices known in the art. The panel fasteners 214 may secure the panels 212 at any height or position on the panel 212 that will not significantly impact the airflow into the chamber 216 via convection to create a swirling flame 201, as discussed above with respect to FIGS. 1-6.

In one embodiment, the panel fasteners 214 may link a vertical edge 220a of a first panel 212a to an interior vertical portion of a second panel 212b such that the second panel has an extension 226 on the exterior of the lamp 210. In another aspect of the illustrated embodiment, the panel fasteners 214 may link the panels 212 such that there is a space between the panels 212. This space may be an air intake slot 228 such that air may flow into the interior flame chamber 216 of the lamp 210. The physical space maintained between the panels 212 may be preserved with the use of spacers (not shown) or by securing the panel fasteners 214 in a manner to accommodate additional space between the panels 212.

The plurality of panels 212, in one embodiment may include four panels 212 and the plurality of panel fasteners 214 may include four panel fasteners 214. In another embodiment, the plurality of panels 212 may include three or more panels 212. In one embodiment, the number of panels 212 may equal the number of air intake slots 228. In a further embodiment, the number of panels 212 may be greater than the number of air intake slots 228. In some embodiments, the number of intake slots 228 is two.

The panels 212 may be permanently attached such that the number of panels 212 of a lamp 210 is fixed. In another embodiment, the number of panels 212 in the lamp 210 is not fixed and additional panels 212 may be removeably attached. In some embodiments, the panel fasteners 214 may be adapted to open and close such that panels 212 may be removed or added to the lamp 210 to make the lamp 210 smaller or larger. Removable attachment of panels 212 may allow the lamp 210 accommodate a smaller or larger space or, in some embodiments, accommodate a smaller or larger flame 201. Additionally, the panels 212, in some embodiments, may be flat. In other embodiments, the panels 212 may be convex or concave.

From the foregoing, it will be appreciated that specific embodiments of the disclosure have been described herein for purposes of illustration, but that various modifications may be made without deviating from the disclosure. Furthermore, aspects of the disclosure described in the context of particular embodiments may be combined or eliminated in other embodiments. Further, while features and characteristics associated with certain embodiments of the disclosure have been described in the context of those embodiments, other embodiments may also exhibit such features and characteristics, and not all embodiments need necessarily exhibit such features and characteristics to fall within the scope of the disclosure. Accordingly, the disclosure is not limited, except as by the appended claims.

I/We claim:

1. A torch lamp system connectable to a source of fuel, comprising:
a burner assembly connectable to the source of fuel and configured to release fuel at a fuel release point for combustion to provide a flame;
a lamp assembly having an interior chamber configured to contain the flame swirling vortically due to air convection therein, the chamber positioned above the fuel release point and having an open upper end portion, the chamber defined by a plurality of panels positioned adjacent to one another along vertical panel edges and spaced apart from one another by gaps, wherein the gaps provide vertically oriented air intake slots between adjacent panels to provide vortical convection airflow therein for swirling the flame; and
a fuel dispersal guide in the chamber positioned above the fuel release point and positioned so fuel flowing from the fuel release point is distributed radially outward from the fuel release point toward the panels.

2. The system of claim 1 wherein the individual panels are aligned to form the chamber, each panel having an extending portion spaced apart from and extending beyond an abutting vertical edge of an adjacent panel.

3. The system of claim 1 wherein the lamp assembly includes a chamber frame for positioning and supporting the plurality of panels to form the chamber.

4. The system of claim 1 wherein the lamp assembly has a chamber frame that includes a base support and a plurality of vertical support bars extending from the base support, the vertical support bars configured to align and support the panels in a spaced apart configuration.

5. The system of claim 1 wherein the lamp assembly has a chamber frame that includes a base support having panel slots, and wherein the panels are receivable in the panel slots and removeably secured in the panel slots with a plurality of pressure bars disposed on the base support.

6. The system of claim 1 wherein the fuel dispersal guide includes a plate having one or more centrally located holes such that fuel flow is distributed radially outward from the fuel release point and centrally through the one or more centrally located holes.

7. The system of claim 1 wherein the fuel dispersal guide includes a plurality of stacked plates supported above the fuel release point, wherein each plate is spaced apart from adjacent plates.

8. The system of claim 7 wherein the fuel dispersal guide includes at least one plate that is a ring having an open center portion.

9. The system of claim 1 wherein the fuel dispersal guide includes—
a bottom plate having an open center portion supported above the fuel release point;
a middle plate having one or more generally centrally located holes, the middle plate being generally vertically aligned with and spaced apart from the bottom plate; and
a top plate having an open center portion, the top plate being generally vertically aligned with and spaced apart from the middle plate.

10. The system of claim 1 wherein the burner assembly includes—
a burner providing the fuel release point and in communication with the fuel source;
a fuel valve control in communication with the fuel source and the burner, the fuel valve control being operable to meter fuel flow from the fuel source to the burner.

11. The system of claim 1 wherein the burner assembly further includes an igniter positioned to ignite fuel released from the fuel release point.

12. The system of claim 1 wherein the burner assembly further includes a thermocouple for detecting un-combusted fuel released from the fuel release point.

13. The system of claim 1, further comprising a mounting assembly for supporting the lamp and burner assemblies.

14. The system of claim 1, further comprising a portable mounting assembly that supports the lamp and burner assemblies and is configured to contain a portable fuel source.

15. The system of claim 1, further comprising a mounting assembly support portion that supports the lamp and the burner assemblies, and a wall bracket coupled to the support portion for attaching to a wall structure.

16. The system of claim 1 wherein the panels are composed of a fire-resistant and generally transparent material.

17. The system of claim 1, further comprising one or more decorative overlays positioned adjacent to the panels.

18. The system of claim 1 wherein the lamp assembly further includes panel fasteners for securing the panels to adjacent panels while maintaining the gaps between the panels.

19. A flame lamp assembly for providing a flame having continuous spiral movement, the flame lamp assembly comprising:
a plurality of spaced apart panels;
a frame for supporting the plurality of spaced apart panels, wherein—
the panels are generally vertically oriented and positioned by the frame to form a chamber for housing the flame;
the frame supports the panels such that adjacent panels are spaced apart from each other at panel junctions along vertical edges of the panels to create a plurality of air intake slots in communication with the chamber;
the panels are off-set from adjacent panels; and
the plurality of air intake slots are in communication with the chamber to allow air to flow from an external environment into the chamber at an angle to provide vortical air flow within the chamber; and
a burner assembly positioned below the chamber and configured to receive fuel from a fuel source and to provide a fuel flow from a fuel release point to the chamber for ignition to provide the flame.

20. The assembly of claim 19, further comprising a fuel dispersal guide in the chamber, the fuel dispersal guide supported above the fuel release point to direct fuel flow from the fuel release point radially outward toward the panels.

21. The assembly of claim 19 wherein the frame has a base support and the panels are coupled to the base support.

22. The assembly of claim 19 wherein the panels are off-set such that individual panels have an extended portion spaced apart from and extending beyond an abutting vertical edge of an adjacent panel.

23. The assembly of claim 19 wherein the burner assembly includes a fuel valve control in communication with the fuel source and configured to meter a fuel flow rate from the fuel source to the fuel release point.

24. The assembly of claim 19 wherein the number of panels is four and the chamber is generally rectangular in shape.

25. The assembly of claim 19 wherein the chamber has an upper open portion in communication with the external environment for releasing heated air from the chamber, and wherein the frame further includes a top cover elevated above the upper open portion.

26. A torch lamp system, comprising:
a burner assembly for receiving fuel from a fuel source and releasing fuel at a fuel release point;
a base positioned over the burner assembly and an inlet disposed in the base, the inlet aligned with the fuel release point such that fuel is directed through the inlet;
a chamber supported by the base in a generally vertical orientation and having an open upper portion spaced apart from the base, the chamber defined by a plurality of panels positioned adjacent to one another along vertical panel edges and spaced apart from one another by gaps, wherein the gaps provide vertically oriented air intake slots between adjacent panels; and
a fuel dispersal guide in the chamber, the fuel dispersal guide having a plate supported at a selected distance above the inlet disposed in the base so that fuel flowing from the fuel release point and through the inlet is distributed radially outward from the fuel release point.

27. The system of claim 26 wherein the individual panels are aligned to form the chamber, each panel having an extending portion spaced apart from and extending beyond an abutting vertical edge of an adjacent panel.

28. The system of claim 26 wherein the fuel dispersal guide includes a plurality of stacked plates supported above the fuel release point, wherein each plate is spaced apart from adjacent plates such that fuel flowing through the inlet is mixed with air between the stacked plates.

29. The system of claim 26 wherein the fuel dispersal guide includes—
a bottom plate having an open center portion supported above the fuel release point;
a middle plate having one or more generally centrally located holes, the middle plate being generally vertically aligned with and spaced apart from the bottom plate; and
a top plate having an open center portion, the top plate being generally vertically aligned with and spaced apart from the middle plate.
